(19) United States
(12) Patent Application Publication
(10) Pub. No.: US 2013/0282341 A1
(43) Pub. Date: Oct. 24, 2013

(54) COST-ESTIMATION SYSTEM, METHOD, AND PROGRAM

(71) Applicant: INTERNATIONAL BUSINESS MACHINES CORPORATION, Armonk, NY (US)

(72) Inventor: Rikiya Takahashi, Tokyo (JP)

(21) Appl. No.: 13/780,220

(22) Filed: Feb. 28, 2013

(30) Foreign Application Priority Data
Mar. 27, 2012 (JP) 2012-070503

(51) Int. Cl. G06F 17/50

(52) U.S. Cl. CPC G06F 17/5009
USPC 703/2

(57) ABSTRACT

A method for estimating a probability density function of values in a link from a distribution of values associated with the link in graph data includes fitting, with a processor, according to the link, a basis function representing the distribution of values in the link; determining an importance scalar representing a weighting of values associated with the link on the basis of a plurality of basis functions corresponding to the link by optimizing a predetermined objective function; and providing the probability density function corresponding to the link by mixing the basis functions with the importance scalar so as to interpolate the basis functions between links similar to the link in the graph data.

### PRIORITY

This application claims priority to Japanese Patent Application No. 2012-070503, filed 27 Mar. 2012, and all the benefits accruing therefrom under 35 U.S.C. §119, the contents of which in its entirety are herein incorporated by reference.

### BACKGROUND

The present invention relates to a system, method, and program for evaluating and predicting costs along a given route among graph-like routes such as traffic routes. Here, cost typically refers to time spent in travel, but can also refer to power or fuel consumption in manufacturing process, and carbon dioxide emissions.

Predicting traffic volume is a significant challenge in urban planning. A typical challenge is to predict travel time required in driving along a route, for the purposes of safety and convenience. As well as such travel time estimation, there is a need to predict consumption of power or fuel, and carbon dioxide emissions. Conventional techniques to address these types of challenges are given as follows.

Laid-open Patent Publication No. 2008-77636 provides a method to compute a stochastically optimal traffic route when a pair of departure and destination points is given. The system deterministically maximizes the probability of reaching the destination in a stochastic graph, whose edge is associated with an independent probability distribution of cost.

Laid-open Patent Publication No. 2011-123003 discloses a device for calculating an index for improving fuel efficiency. This device, which calculates an index for how to drive with good fuel efficiency, includes a vehicle speed calculating unit for calculating the rate of change in vehicle speed over a very short period of time, a fuel consumption calculating unit for calculating the rate of change in fuel consumption over a very short period of time, and a variance analysis unit for calculating the variance in the rate of change in vehicle speed and the variance in the rate of change in fuel consumption. An index for how to drive with good fuel efficiency is then calculated based on these variances.

However, these conventional techniques require sufficient information about the probability distributions of cost on the edges. WO 2011/074369 provides a technique to predict the cost between a given start point and end point, even when some information on past routes is missing. In this technique, when a pair consisting of a route and a route cost is provided as training data, a subroutine calculates the cost ce along the given link e. Here, the cost ce can be uniquely calculated from the variable referred to as fe in the document WO 2011/074369. In other words, it is assumed that fe is also uniquely determined when ce is given. In the initial step, the minimum cost route is sought from the current {fe} for all start point/end point pairs included in the data D. As a result, the data D is converted into sets of pairs (route, route cost). Thus, the converted D is expressed by D′. In this step, the computer processing recalculates {fe} from D′ using the subroutine. The recalculated {fe} is compared to the previously calculated {fe}, and the process returns to the step for seeking the minimum cost route if the result is equal to or greater than a threshold value for the change. Otherwise, {fe} is set.

However, in the technique of WO 2011/074369, the distribution of travel times for a link is limited to a normal distribution because an ordinary-least-square regression method is used. As a result, existence of a heavy tail in the distribution, which represents a phase of extreme traffic congestion, cannot be taken into account.

Another well-known technique used to estimate travel time is a technique to compute a diffusion kernel matrix described in Risi Imre Kondor, John Lafferty, “Diffusion Kernels on Graphs and Other Discrete Spaces”, International Conference on Machine Learning, 2002. However, the computational time to compute the matrix of diffusion kernels exceeds the allowable range in practice, because the size of a road network tends to be huge.

### SUMMARY

In one embodiment, a method for estimating a probability density function of values in a link from a distribution of values associated with the link in graph data includes fitting, with a processor, according to the link, a basis function representing the distribution of values in the link; determining an importance scalar representing a weighting of values associated with the link on the basis of a plurality of basis functions corresponding to the link by optimizing a predetermined objective function; and providing the probability density function corresponding to the link by mixing the basis functions with the importance scalar so as to interpolate the basis functions between links similar to the link in the graph data.

In another embodiment, a computer readable storage medium has computer readable instructions stored thereon that, when executed by a computer, implement a method for estimating a probability density function of values in a link from a distribution of values associated with the link in graph data. The method includes fitting, with the computer, according to the link, a basis function representing the distribution of values in the link; determining an importance scalar representing a weighting of values associated with the link on the basis of a plurality of basis functions corresponding to the link by optimizing a predetermined objective function; and providing the probability density function corresponding to the link by mixing the basis functions with the importance scalar so as to interpolate the basis functions between links similar to the link in the graph data.

In another embodiment, a computer processing system for estimating a probability density function of values in a link from a distribution of values associated with the link in graph data includes a computer configured to: fit, according to the link, a basis function representing the distribution of values in the link; determine an importance scalar representing a weighting of values associated with the link on the basis of a plurality of basis functions corresponding to the link by optimizing a predetermined objective function; and provide the probability density function corresponding to the link by mixing the basis functions with the importance scalar so as to interpolate the basis functions between links similar to the link in the graph data.

### BRIEF DESCRIPTION OF THE SEVERAL VIEWS OF THE DRAWINGS

FIG. 1 is a block diagram of an example of a hardware configuration for embodying the present invention.

FIG. 2 is a function block diagram of a processing routine for embodying the present invention.

FIG. 3 is a diagram showing the travel time relationship of graph data and links.

FIG. 4 is a flowchart of the processing routine performed by the basic estimation unit.

FIG. 5 is a flowchart of the processing routine performed by the cross-validation unit.

### DETAILED DESCRIPTION

In one aspect, the present invention embodiments provide a technique to predict travel time for each road link with the greatest possible accuracy, even when the amount of observed samples about the costs associated with edges is very small.

In another aspect, the present invention embodiments provide a technique to predict travel time for each road link, where distribution of the cost in each link is not a normal distribution.

In another aspect, the present invention embodiments provide a technique to predict travel time for each link with realistic computational time, even when there is a large number of observations about travel time samples.

The present invention embodiments provide a technique for estimating the probability distribution of a random variable on any edge of a graph representing, for example, a road network, using a probability density function that is able to accommodate any distribution when an observed value for the variable is on the edge.

The probability density function is the following equation which mixes a basis function estimated from data divided for each edge, a similarity scalar between two edges, and an importance scalar for each edge.

$$P ( {Y}_{l} = y ) = \frac{{λ}_{0} {φ}_{0} ( y ) + {\sum }_{i = 1}^{m} {λ}_{i} K ( e , {e}_{π [ i ]} ) {φ}_{i} ( y )}{{λ}_{0} + {\sum }_{i = 1}^{m} {λ}_{i} K ( e , {e}_{π [ i ]} )} \qquad Equation 1$$

In this equation, e is an edge whose distribution is to be fitted, Ye is a random variable for edge e, eπ[1], . . . , eπ[m] are edges that associate with observations of cost, φ1, . . . , φm are basis functions assigned to each edge, λ1, . . . , λm are non-negative importance scalars for each edge, K(e, eπ[i]) is a non-negative similarity scalar for a pair of edges e and edge eπ[i], φ0 is a global basis function independent from any edge, and λ0 an importance scalar for the global basis function.

As can be seen above, the probability density function assumes a form which interpolates the basis functions of edges that are similar to each other.

The basis functions φ0, φ1, . . . , φm can be any function, even a normal distribution probability density function as long as the condition of the probability density function is met where the integral over the all input space is one. Their arguments can be multidimensional.

In the system, functions φ0, φ1, . . . , φm are determined from the data before this equation is applied. Next, the system of the present invention determines λ0, λ1, . . . , λm from functions φ0, φ1, . . . , φm using, for example, the fast convex clustering technique described in Rikiya Takahashi, “Sequential Minimal Optimization in Convex Clustering Repetitions”, Statistical Analysis and Data Mining, Volume 5, Issue 1 (Special Issue: Best Papers of SDM '11), pages 70-89, 2012.

An importance scalar λi determined in this way is needed to reflect the differences in the estimation reliability of each edge. For example, an edge in which many samples have been observed possesses a high importance.

A basis function φ0 and an importance scalar λ0 independent from any edge are needed in calculating the distribution with respect to edges having no similarity values with other edges that are assigned observations of cost.

According to one aspect, parameters in the probability density function are optimized quickly and stably from finite data. In other words, L probability density functions in a well-known function form such as a gamma distribution density function are prepared, and each basis function is expressed as a linear interpolation of L probability density functions. The weights required in these linear interpolations are preferably determined using the fast convex clustering technique described above.

The importance scalars are preferably provided as a negative Laplacian matrix H of the graph between adjacent edges, and predetermined parameters.

When the basis functions and similarity scalars are obtained in this way, they are preferably optimized so as to maximize the objective function in the Kullback-Leibler Importance Estimation Procedure introduced in Sugiyama, M., Suzuki, T., Nakajima, S., Kashima, H., von Bunau, P. and Kawanabe, M. Direct importance Estimation For Covariate Shift Adaptation. Annals of the Institute of Statistical Mathematics, Vol. 60, No. 4, pp. 699-746, 2008, and so as to determine the link importance λ0, λ1, . . . , λm. In this situation, the fast convex clustering technique described above is preferably used.

When a probability density function is configured in this way, many types of statistics in the distribution of cost can be calculated, based on the probability of each link along a route.

The present invention embodiments are able to provide sufficient accuracy in fitting distribution, even for edges whose observations are missing or very limited, without compromising the prediction accuracy for other edges that have sufficient numbers of observations.

The present invention embodiments are also able to more efficiently process larger amounts of data than nonparametric density estimations in the prior art, because the probability density functions can be optimized with a significantly lower computational load.

The following is an explanation of embodiments of the present invention with reference to the drawings. The embodiments explained below are preferred embodiments of the present invention, and it should be understood that there is no intent to limit the scope of the present invention to the embodiments shown here. In the drawings described below, the same reference signs are used to denote the same objects unless otherwise noted.

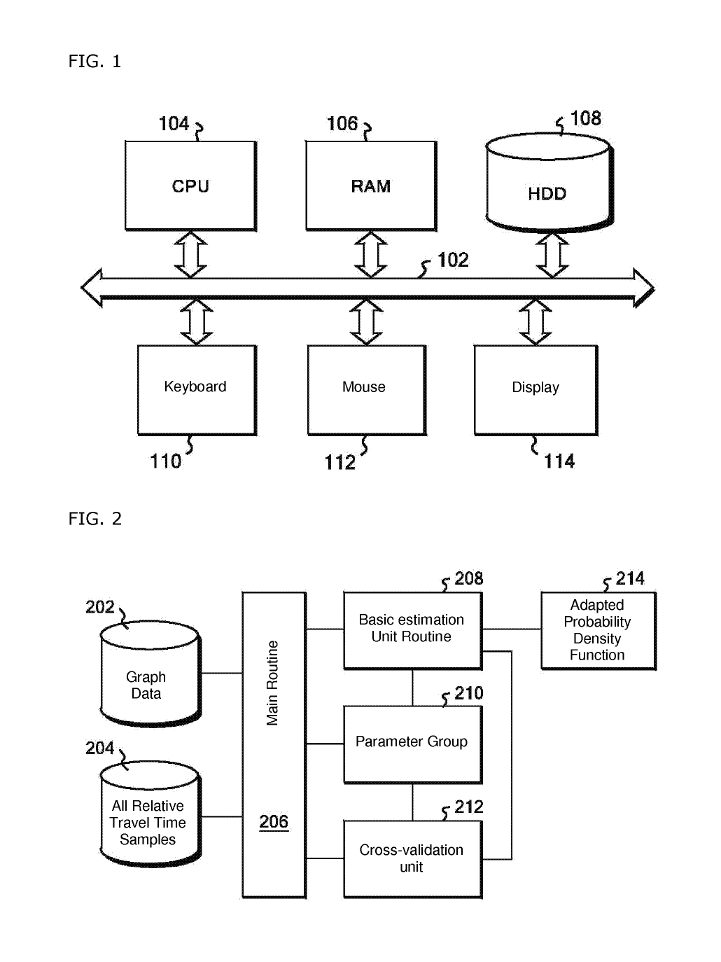

FIG. 1 is a block diagram of computer hardware used to realize the system configuration and processing in an embodiment of the present invention. In FIG. 1, a CPU 104, main memory (RAM) 106, hard disk drive (HDD) 108, keyboard 110, mouse 112, and display 114 are connected to a system bus 102. The CPU 104 is preferably based on a 32-bit or 64-bit architecture. Pentium (trademark) 4 from Intel, Core (trademark) 2 Duo from Intel, or Athlon (trademark) from AMD can be used. The main memory 106 preferably has a storage capacity of at least 4 GB, and more preferably has a storage capacity of at least 16 GB.

An operating system is stored in the hard disk drive 108. Examples of operating systems include Linux (trademark), Windows (trademark) 7, Windows XP (trademark) and Windows (trademark) 2000 from Microsoft Corporation, and MacOS (trademark) from Apple Computer. The operating system should be compatible with the CPU 104.

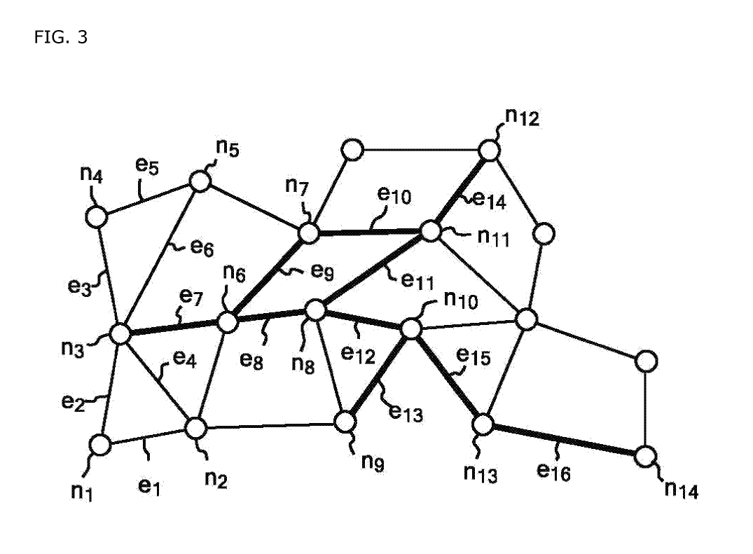

As explained below with reference to FIG. 2 and FIG. 3, route graph data 202 and all relative travel time samples 204 are stored in the hard disk drive 108. The route graph data 202 basically includes target nodes in the road network as well as the length and direction of the links. This data can be converted and created from map information data. All relative travel time samples 204 are preferably created from probe car data collected from a plurality of vehicles. Here, a value for the relative travel time required by a vehicle to actually pass through a link (edge) in the graph data 202 is associated with the link and stored. The relative travel time is a value whose numerator is the absolute time required for an actual vehicle to travel a given link, and whose denominator is a reference time for traveling the same link at the legal speed limit. Preferably, the graph data 202 and the data in all relative travel time samples 204 is written using well-known matrix expressions, and stored in the hard disk drive 108.

As explained below with reference to FIG. 2, the hard disk drive 108 stores a main routine 206, a basic estimation unit routine 208, parameter group data 210, and a cross-validation unit routine 212. The basic estimation unit routine 208 and the cross-validation unit routine 212 can be compiled and stored in the hard disk drive 108 as executable files using any existing programming language such as C, C++, C# or Java®. These routines can be loaded in the main memory 106 and executed by the operating system in response to a user operation whenever they are required.

The keyboard 110 and the mouse 112 are used to manipulate graphic objects such as icons, task bars and windows displayed on a display 114 in accordance with the graphic user interface provided by the operating system. The keyboard 110 and mouse 112 are also operated by the user to enter a start point and end point, and to start and end a program according to the embodiment of the present invention.

There are no particular restrictions, but the display 114 is preferably a 32-bit true color LCD monitor with a resolution of at least 1024×768. The display 114 is used, for example, to display statistics related to travel times for specified links.

The following is an explanation of the configuration of the function logic block diagram of the present invention with reference to FIG. 2. In FIG. 2, the main routine 206 has an interface function for displaying a control panel (not shown) in the display 114 in response to operations performed by the keyboard 110 or the mouse 112, a function for reading graph data 202 and data in all relative travel time samples 204, and a control function for operating the basic estimation unit routine 208 and the cross-validation unit routine 212.

The parameter group 210 includes parameter groups used by the basic estimation unit routine 208 and the cross-validation unit 212. The parameter group includes metaparameter L, metaparameter r, metaparameter β, metaparameter p, the number of metaparameter types T, and the number of fields F. The appropriate values can be set beforehand in the parameter group by the operator. However, the optimum parameters are preferably calculated and converted by the cross-validation unit routine 212.

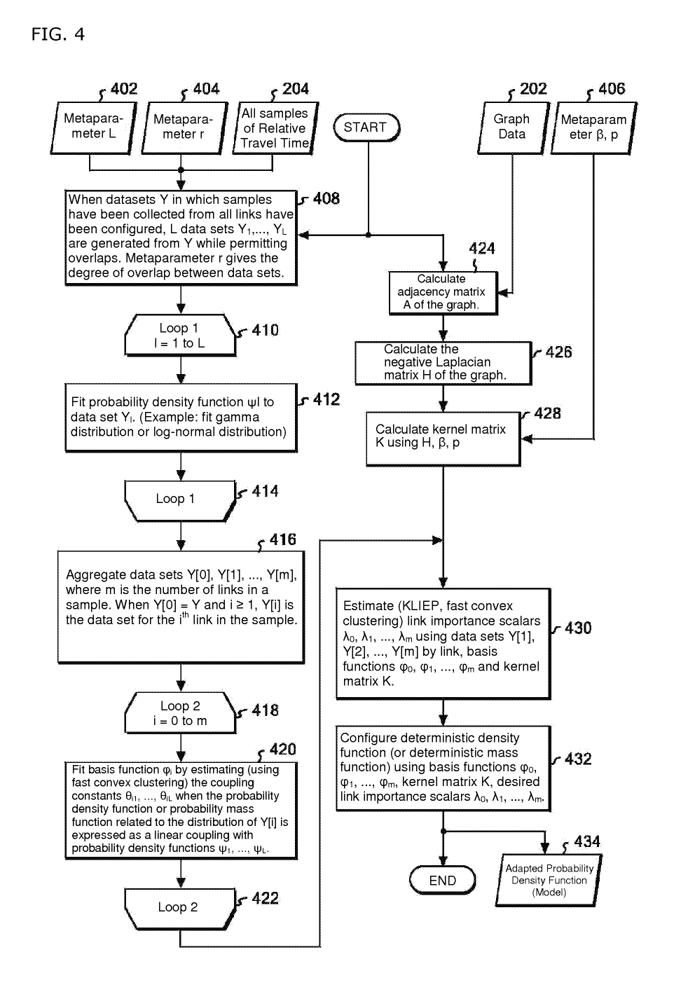

The basic estimation unit routine 208 has a function for setting an adapted probability density function 214 using graph data 202, data in the relative travel time samples 204, and the parameter group 210. The adapted probability density function 214 is preferably stored in the hard disk drive 108 and used to calculate statistics such as the distribution of travel times for the desired link. The processing performed by the basic estimation unit routine 208 will be explained in greater detail below with reference to the flowchart in FIG. 4.

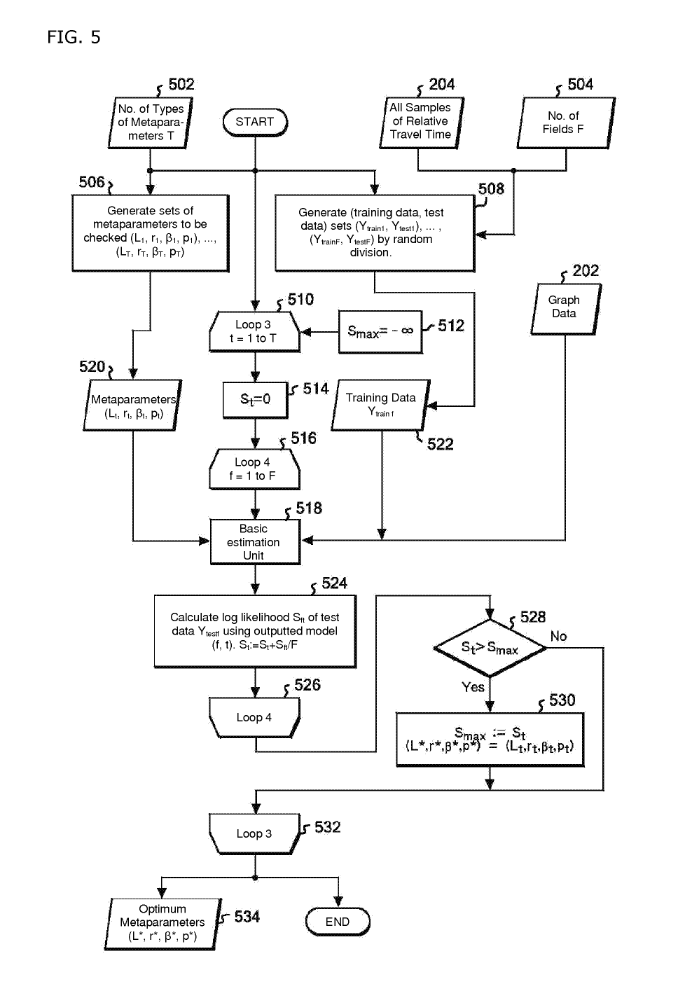

The cross-validation unit routine 212 executes a higher-level optimization process that optimizes metaparameters by calling up the functions of the basic estimation unit routine 208 with cross-validation. The processing performed by the cross-validation unit routine 212 will be explained in greater detail below with reference to the flowchart in FIG. 5.

FIG. 3 is a diagram used to illustrate the graph data 202 and data in all relative travel time samples 204. The graph data 202 has nodes indicated by node n1, . . . , node n14, and links (edges) indicated by link e1, . . . , link e16. For the sake of convenience, the reference signs for some of the nodes and links in the graph data 202 shown in FIG. 3 have been omitted. However, in actual graph data, an ID is assigned to all nodes and links for identification purposes.

The data in all relative travel time samples 204 are related to individual links. For example, relative travel times acquired from probe car data are recorded. It should be understood that relative travel times are not recorded for all of the links in the graph data 202. In FIG. 3, links with recorded relative travel times are indicated by a thicker line, and links without recorded relative travel times, that is, links for which probe car data has not been acquired, are indicated by a thinner line.

Here, relative travel times have been recorded for the following routes.

Path 1: Starting from node n3, node n12 is reached via e7→e8→e11→e14.

Path 2: Starting from node n3, node n12 is reached via e7→e9→e10→e14.

Path 3: Starting from node n3, node n14 is reached via e7→e8→e12→e15→e16.

Path 4: Starting from node n9, node n14 is reached via e13→e15→e16.

It can be seen from this that, for example, path 1, path 2 and path 3 pass through e7. Because different relative travel times are obtained at e7 for path 1, path 2 and path 3, different relative travel times are associated with a single link. The data for all relative travel time samples 204 includes a plurality of relative travel time data sets associated with individual links. When there is a plurality of data sets for relative travel times, probability density functions for relative travel times can be calculated for individual links. These probability density functions for relative travel times will be explained with reference to the flowchart in FIG. 4.

The following is an explanation of the basic estimation unit routine 208 with reference to the flowchart in FIG. 4. The basic estimation unit routine 208 executes processing using as inputs metaparameter L indicated by reference sign 402, metaparameter r indicated by reference sign 402, all relative travel time samples 204, graph data 202, and metaparameters β, p indicated by reference sign 406.

Metaparameter L indicates the number of probability density coefficients ψi, metaparameter r indicates the positive scalar for adjusting the bandwidth of the estimated distribution, and metaparameters β and p are used to calculate the kernel matrix K.

When the process starts, in Block 408, the basic estimation unit routine 208 configures data set Y in which relative travel time samples for all of the links in graph data 202 have been collected. In other words, the basic estimation unit routine 208 collects the relative travel time samples for all of the links into a single set without regard to link, and sorts the samples by relative travel time to obtain data set Y. Then, L data sets Y1, . . . , YL are generated from Y while permitting overlap in accordance with metaparameter r. In other words, when data set Y has N samples, it divides the whole number of samples closest to rN/L into data sets Y1, . . . , YL in the sorted order. The value for r can be any appropriate number such as 1, 1.5 or 2. The value is determined with cross-validation, but it has been confirmed experimentally that r=1.5 is the optimum value when L=100.

The process from Block 410 to Block 414 is a loop from l=1 to L. In Block 412 of the loop, the basic estimation unit routine 208 fits probability density function ψ1 to data set Y1 using a maximum likelihood estimate. Here, ψ1 is preferably either a gamma distribution or a log-normal distribution. Because the estimate is an estimate with respect to an exponential family, convex optimization is possible and the parameter is uniquely determined.

When loops l=1 to L have been completed from Block 410 to Block 414, probability density functions ψ1, . . . , ψL are complete.

In Block 416, the basic estimation unit routine 208 aggregates data sets Y[0], Y[1], . . . , Y[m]. Here, m is the number of links in the relative travel time samples (links with thick lines in FIG. 3). When Y[0]=Y and i≧1, Y[i] is the data set for the i^{th} link in the sample.

The process from Block 418 to Block 422 is a loop from i=0 to m. In Block 420 of the loop, the basic estimation unit routine 208 fit basis function φi by using fast convex clustering on the coupling constants θi1, . . . , θiL when the probability density function or probability mass function related to the distribution of Y[i] is expressed as a linear coupling with probability density functions ψ1, . . . , ψL. The equation is written as follows.

$${φ}_{i} ( y ) = {\sum }_{l = 1}^{L} {θ}_{u} {ψ}_{i} ( y ) \qquad Equation 2$$

Here, any method for estimating a mixture of gamma distributions or mixture of log-normal distributions can be used for the clustering. For example, EM algorithms, and variational Bayesian methods exploiting Hierarchical Dirichlet process can be used. In this embodiment, the preferred clustering technique is the fast convex clustering technique described in Rikiya Takahashi, “Sequential Minimal Optimization in Convex Clustering Repetitions”, Statistical Analysis and Data Mining, Volume 5, Issue 1 (Special Issue: Best Papers of SDM '11), pages 70-89, 2012. This technique is described in the specification of Patent Application No. 2010-241065.

The following is a more detailed description. First, the samples of relative travel time included in data set Y[i] are described as y[i, j] (j=1, 2, . . . , n[i]). Here, n[i] is the number of relative travel time samples included in data set Y[i].

The kernel vector for data set Y[i] required by the fast convex clustering technique is k[i, l] (l=1, 2, . . . , L). This component is written as follows.

k[i,l]=(ψₗ(y[i,1]), ψₗ(y[i,2]), . . . , ψₗ(y[i,n[i]]))^{T} Equation 3

When kernel vector k[i, l] is provided in this way and applied to the fast convex clustering technique, λ1, . . . , λL described in the specification of Patent Application No. 2010-241065 are obtained. Thus, interpolation weights θi1, . . . , θiL are determined considering that θi1=λ1, . . . , θiL=λL.

When loops i=0 to m have been completed from Block 418 to Block 422, the interpolation weights θi1, . . . , θiL have been determined from i=0 to m.

Meanwhile, in Block 424, the basic estimation unit routine 208 prepares an adjacency matrix A of the graph from graph data 202 in the following way.

(1) A two-dimensional array of matrix A={aij} is prepared so the size is (no. of links)×(no. of links).

(2) When link (having a direction in the smallest unit of road between intersections) ei and link ej are physically connected, aij=0.5+0.5* is the cosine similarity between links. Here, aij=0 when ej is not physically connected. The cosine similarity is the inner product divided by the magnitude of the vector. The following is a description of the equation.

$${a}_{i , j} = \{ \begin{matrix}\frac{1}{2} + \frac{{Δ}^{T} ( {e}_{i} ) Δ ( {e}_{j} )}{2 \vert \vert Δ ( {e}_{i} ) \vert \vert \vert \vert Δ ( {e}_{j} ) \vert \vert} & if {u}_{i} = {v}_{j} or {v}_{i} = {u}_{j} \\ 0 & otherwise\end{matrix} \qquad Equation 4$$

In the equation, ui is the start point and vi is the end point of link ei, and uj is the start point and vj is the end point of link ej. Also, Δ(ei) is a two-dimensional vector with the direction of link ei.

When the adjacency matrix A of the graph is sought in this way, the basic estimation unit routine 208 in Block 426 calculates a matrix D defined by the following equation.

$$D = diag ( {\sum }_{j = 1`}^{\vert E \vert} {a}_{1 j} , … , {\sum }_{j = 1}^{\vert E \vert} {a}_{\vert E \vert j} ) \qquad Equation 5$$

Here, diag( ) represents a diagonal matrix, and |E| represents the number of links.

The negative Laplacian matrix H of the graph is calculated using the following equation.

H=D^{-1/2}(A−D)D^{-1/2} Equation 6

When the negative Laplacian matrix H of the graph has been calculated in this way in Block 426, the basic estimation unit routine 208 in Block 428 calculates the kernel matrix K with the following equation using matrix H and parameters β, p.

$$K ( β , p ) = {( 1 + \frac{β}{p} H )}^{p} = {\sum }_{q = 0}^{p} \frac{p ! {β}^{q`}}{q ! ( p - q ) ! {p}^{q}} {H}^{q} \qquad Equation 7$$

The various components in the kernel matrix K calculated in this way are used as similarity scalars between edges K(e, eπ[i]). As is clear from this equation, interpolation is made to work between edges that are not directly adjacent to each other, by providing it as a power of a sparse matrix using the original negative Laplacian matrix H of the graph between edges and parameters β, p. The preferred value for p is 8, and the preferred value for β is from 1 to 5. p can be selected within a value range from 8 to 20. However, the number of non-zero components in the matrix increases as p increases, and more memory is required. Therefore, p is selected within the resource range available to the computer. β does not have to be an integer, and can be a real number equal to or less than 0. However, β is preferably smaller than p in order to ensure approximation accuracy.

In Block 430, the basic estimation unit routine 208 computes the link importance scalar λ0, λ1, . . . , λm using the data set for each link Y[0], Y[1], . . . , Y[m] prepared in Block 416, the basis functions φ0, φ1, . . . , φm prepared in Blocks 418-422, and the kernel matrix K prepared in Block 428. Preferably, this is optimized with maximizing the objective function in the Kullback-Leibler Importance Estimation Procedure (KLIEP). KLIEP is an algorithm for directly estimating the ratio of two density functions without perform density estimation for each function, and is described in Sugiyama, M., Suzuki, T., Nakajima, S., Kashima, H., von Bunau, P. and Kawanabe, M. Direct Importance Estimation for Covariate Shift Adaptation. Annals of the Institute of Statistical Mathematics, vol. 60, no. 4, pp. 699-746, 2008. The fast convex clustering technique described in Rikiya Takahashi, “Sequential Minimal Optimization in Convex Clustering Repetitions”, Statistical Analysis and Data Mining, Volume 5, Issue 1 (Special Issue: Best Papers of SDM '11), pages 70-89, 2012, can be used to perform this calculation within a realistic time frame.

When the importance scalars λ0, λ1, . . . , λm have been estimated in Block 430, the basic estimation unit routine 208 in Block 432 configures the probability density function (or probability mass function) P(ye=y) using the following equation, and in Block 434 makes it available to the other program or routine as the adapted probability density function 214.

$$P ( {Y}_{e} = y ) = \frac{{λ}_{0} {φ}_{0} ( u ) + {\sum }_{i = 1}^{m} {λ}_{i} K ( e , {e}_{π [ i ]} ) {φ}_{i} ( y )}{{λ}_{0} + {\sum }_{i = 1}^{m} {λ}_{i} K ( e , {e}_{π [ i ]} )} \qquad Equation 8$$

Here, eπ[1], . . . , eπ[m] are edges having observations of cost.

The following is an explanation of the processing performed by the cross-validation unit routine 212 with reference to the flowchart in FIG. 5. The cross-validation unit routine 212 optimizes the metaparameters L, r, β, p used in the basic estimation unit routine 208, in which the inputs are the number of metaparameter types T indicated by reference sign 502, the number of fields F indicated by reference sign 504, all relative travel time samples 204, and the graph data 202.

In Block 506, the cross-validation unit routine 212 generates sets of parameters to be checked divided by type T (L1, r1, β1, p1), . . . , (LT, rT, βT, pT).

In Block 508, the cross-validation unit routine 212 generates (training data, test data) sets (Ytrain1, Ytest1), . . . , (YtrainF, YtestF) randomly divided by field F. Then, in the main processing performed by the cross-validation unit routine 212, t and f are combined by turning the loop related to f through the loop related to t, the parameter sets and (training data, test data) sets are provided to the basic estimation unit routine 208, the logarithmic likelihood is calculated, and the optimum parameters are substituted based on the results.

The cross-validation unit routine 212 starts the outer loop related to t from Block 510, and sets Smax=−∞ at the beginning of the loop in Block 512.

Next, in Block 514, the cross-validation unit routine 212 sets St=0.

The inner loop related to f is entered from Block 516.

In Block 518, the cross-validation unit routine 212 provides the metaparameter set (Lt, rt, βt, pt) indicated by reference sign 520, and the training data Ytrainf indicated by reference sign 522 along with graph data 202 to the basic estimation unit routine 208 in accordance with the t and f values, and a model is estimated.

In Block 524, the cross-validation unit routine 212 uses the model (f, t) outputted in this way to calculate the logarithmic likelihood of test data Ytestf, and builds up a value in St using St:=St+Sft/F.

When 1 to F has been completed in Block 516 through Block 526, the cross-validation unit routine 212 determines whether St>Smax in Block 528. If so, the cross-validation unit routine 212 sets Smax:=St in Block 530, and the process advances to Block 532 where (L*, r*, β*, p*)=(Lt, rt, βt, pt) is the end of the outer loop related to t.

When t=1 to T has been repeated from Block 510 to Block 532, the result (L*, r*, β*, p*) is set as the optimum parameter 534, and the cross-validation unit routine 212 is ended.

Next, the main routine 206 performs the estimation process of the basic estimation unit 208 using the optimized parameters (L*,r*,β*,p*), and updates the adapted probability density function 214.

The processing performed by the cross-validation parameter setting unit routine 212 is not essential. The basic estimation unit routine 208 only has to be operated once using reasonable parameters known in advance. Cross-validation is performed when the reasonable parameters are unclear, and optimization has to be performed based on the data.

When the adapted probability density function 214 has been obtained, any value in which a probability density function is used can be calculated, such as the average travel time along a given link, or α% tile value.

The average travel time along a given link is calculated, for example, in the following way.

(Equation 10) is calculated for the basis functions φi(y) (i=0, 1, . . . , m) in (Equation 9).

$$\begin{matrix}P ( {Y}_{e} = y ) = \frac{{λ}_{0} {φ}_{0} ( u ) + {\sum }_{i = 1}^{m} {λ}_{i} K ( e , {e}_{π [ i ]} ) {φ}_{i} ( y )}{{λ}_{0} + {\sum }_{i = 1}^{m} {λ}_{i} K ( e , {e}_{π [ i ]} )} & Equation 9 \\ {μ}_{i} = \int y {φ}_{i} ( y ) d y & Equation 10\end{matrix}$$

The equation (Equation 11) in which each μi has been substituted represents the average related to the absolute values of the travel times for the given link.

$$\frac{{λ}_{0} {μ}_{0} + {\sum }_{i = 1}^{m} {λ}_{i} K ( e , {e}_{π [ i ]} ) {μ}_{i}}{{λ}_{0} + {\sum }_{i = 1}^{m} {λ}_{i} K ( e , {e}_{π [ i ]} )} \qquad Equation 11$$

The α% tile value along a given link can be calculated by replacing the basis function φi(y) with a cumulative distribution function obtained with integrating φi(y) in the entire space of y.

In the embodiment, the basis function group φi for providing the adapted probability density function mixed with an importance scalar is prepared as a linear interpolation with another probability density function group ψi. However, the present invention is not limited to this. Depending on the situation, a basis function group φi can be fitted directly.

However, it is statistically preferable in a computer that basis function groups φi be represented as linear interpolation with a smaller number of probability density function groups ψi.

By representing m basis function groups φi as linear interpolation with a smaller number of probability density function groups ψi (L<m), the basis functions φi become mixed gamma functions or mixed log-normal distributions, and the expressive power of the basis functions φi becomes stronger, even when ψi is a relatively small number of easy-to-calculate probability density functions such as gamma functions or log-normal distributions.

However, the probability density functions used as the probability density functions ψi are not limited to gamma functions and log-normal distributions. In addition to the usage of exponential family distributions, heavy-tailed distributions including Student t distribution and Pareto distribution can be used.

An embodiment was explained above in which a probability density function related to travel time along links in a traffic route were sought. However, the present invention can also be used to estimate any probability mass or the probability density of any amount associated with a link such as power consumption, fuel consumption and carbon dioxide emissions. Probability mass functions can be processed in the same way as probability density functions as described in Block 420 of the flowchart in FIG. 4.

A computer system used to implement the present invention is not limited to a particular platform such as hardware architecture or operating system. It can be implemented using any platform.

1. A method for estimating a probability density function of values in a link from a distribution of values associated with the link in graph data, the method comprising:
fitting, with a computer, according to the link, a basis function representing the distribution of values in the link;
determining an importance scalar representing a weighting of values associated with the link on the basis of a plurality of basis functions corresponding to the link by optimizing a predetermined objective function; and
providing the probability density function corresponding to the link by mixing the basis functions with the importance scalar so as to interpolate the basis functions between links similar to the link in the graph data.

2. The method of claim 1, further comprising:
generating a plurality of divided datasets by splitting collected data after values associated with a link in graph data have been collected;
fitting a probability density function to each divided data set;
determining, using a convex clustering technique, a coefficient representing the basis functions as a linear interpolation with the probability density function of each divided data set; and
representing, with the determined coefficient, each basis function as a linear interpolation with the probability density function of each divided set.

3. The method of claim 2, wherein the probability density function for each divided data set is a gamma distribution or log-normal distribution, and the basis function is a mixed gamma distribution or mixed log-normal distribution.

4. The method of claim 1, wherein the objective function is an objective function defined by the Kullback-Leibler Importance Estimation Procedure.

5. The method of claim 4, wherein optimization of the objective function is performed with a convex clustering technique.

6. The method of claim 1, wherein the graph data represents a road network, and the value associated with the link is travel time.

7. A computer readable storage medium having computer readable instructions stored thereon that, when executed by a computer, implement a method for estimating a probability density function of values in a link from a distribution of values associated with the link in graph data, the method comprising:
fitting, with the computer, according to the link, a basis function representing the distribution of values in the link;
determining an importance scalar representing a weighting of values associated with the link on the basis of a plurality of basis functions corresponding to the link by optimizing a predetermined objective function; and
providing the probability density function corresponding to the link by mixing the basis functions with the importance scalar so as to interpolate the basis functions between links similar to the link in the graph data.

8. The computer readable storage medium of claim 7, wherein the method further comprises:
generating a plurality of divided datasets by splitting collected data after values associated with a link in graph data have been collected;
fitting a probability density function to each divided data set;
determining, using a convex clustering technique, a coefficient representing the basis functions as a linear interpolation with the probability density function of each divided dataset; and
representing, with the determined coefficient, each basis function as a linear interpolation with the probability density function of each divided set.

9. The computer readable storage medium of claim 8, wherein the probability density function for each divided data set is a gamma distribution or log-normal distribution, and the basis function is a mixture of gamma distributions or mixture of log-normal distribution.

10. The computer readable storage medium of claim 7, wherein the objective function is an objective function defined by the Kullback-Leibler Importance Estimation Procedure.

11. The computer readable storage medium of claim 10, wherein optimization of the objective function is performed using a convex clustering technique.

12. The computer readable storage medium of claim 7, wherein the graph data represents a road network, and the value associated with the link is travel time.

13. A computer processing system for estimating a probability density function of values in a link from a distribution of values associated with the link in graph data, the system comprising:
a computer configured to: fit, according to the link, a basis function representing the distribution of values in the link;
determine an importance scalar representing a weighting of values associated with the link on the basis of a plurality of basis functions corresponding to the link by optimizing a predetermined objective function; and
provide the probability density function corresponding to the link by mixing the basis functions with the importance scalar so as to interpolate the basis functions between links similar to the link in the graph data.

14. The system of claim 13, wherein the computer is further configured to:
generate a plurality of divided data sets by dividing collected data after values associated with a link in graph data have been collected;
fit a probability density function to each divided data set;
determine, using a convex clustering technique, a coefficient representing the basis functions as a linear coupling with the probability density function of each divided data set; and
represent, with the determined coefficient, each basis function as a linear coupling with the probability density function of each divided set.

15. The system of claim 14, wherein the probability density function for each divided data set is a gamma distribution or log-normal distribution, and the basis function is a mixture of gamma distributions or mixture of log-normal distributions.

16. The system of claim 13, wherein the objective function is an objective function defined by the Kullback-Leibler Importance Estimation Procedure.

17. The system of claim 16, wherein optimization of the objective function is performed using a convex clustering technique.

18. The system of claim 13, wherein the graph data represents a road network, and the value associated with the link is travel time.
